(19) United States
(12) Patent Application Publication
(10) Pub. No.: US 2018/0160257 A1
(43) Pub. Date: Jun. 7, 2018

(54) METHOD FOR CONFIGURING DEVICES AND CORRESPONDING DEVICES

(71) Applicant: Continental Automotive GmbH, Munchen (DE)

(72) Inventors: Martin Ebneter, Rebstein (CH); Markus Hasler, Montlingen (CH)

(21) Appl. No.: 15/407,195

(22) Filed: Jan. 16, 2017

(30) Foreign Application Priority Data
Dec. 5, 2016 (DE) 10 2016 244158.3

(51) Int. Cl. H04W 4/00

(52) U.S. Cl. CPC H04W 4/008

(57) ABSTRACT

A method for configuring a first device 1 by means of a second device 2 comprises the following steps: detection S11 of an active NFC device by means of an NFC module 12, in the passive NFC mode, of the first device 1. If the active NFC device is the second device 2, outputting S12 of status feedback by the first device 1 by means of its NFC module 12 in the passive NFC mode. Reception S13 of configuration data emitted by the second device 2 by the NFC module 12 of the first device 1 in the passive NFC mode. Storage of the received configuration data in a configuration data memory 11 of the first device 1. Starting of the configuration S15 by the first device 1 or of operation S16 of the first device 1 on the basis of the stored configuration data.

### CROSS-REFERENCE TO RELATED APPLICATIONS

The present application claims priority to German Patent Application No. 10 2016 244158.3, which is assigned to the same assignee as the present application.

### FIELD OF THE INVENTION

The present invention relates to a method for configuring a first device by means of a second device, and to corresponding devices.

### BACKGROUND AND OBJECTS OF THE INVENTION

EP 3 035 552 A1 discloses the general concept of carrying out configuration information for a device by means of near field communication, also known as NFC, from a mobile device. Here, configuration information is firstly loaded from the device onto the mobile device and modified there, and the modified configuration information is again transmitted from the mobile device to the device.

U.S. Pat. No. 9,058,550 B2, EP 2 199 946 A1 and U.S. Pat. No. 9,184,801 B2 present the general concept of transmitting configuration information by means of near field communication, but here to a switched-off device whose near field communication module buffers the configuration information and transmits it to the device after said device has been switched on. U.S. Pat. No. 7,825,776 B2 also discloses a corresponding buffering process.

In U.S. Pat. No. 8,718,554 B2, in addition to the near field communication at least one further wireless communication channel is opened and used in order to transmit configuration data from one device to another.

U.S. Pat. No. 9,197,312 B2 discloses a system for near field communication. Inter alia, data is synchronized between two NFC devices, keys or other codes are transferred, user profiles are exchanged or different automation functionalities of a building are accessed.

Instruments, devices and control units require in many applications, in particular in land vehicles or seacraft, what is referred to as a set-up or a configuration which is often implemented via what is referred to as a CAN bus or other hard-wired connections. The set-up parameters are stored locally in the device, usually as what is referred to as firmware, by means of a firmware update in a read-only memory, referred to as an EEPROM. The connections via a CAN bus or some other hard-wired data bus are expensive, complex or difficult to handle, in particular if a specific further device is necessary.

The object of the invention is to specify a further possible way of configuring a device, in particular by applying the near field communication which is referred to in the following text by the abbreviation NFC.

A method according to the invention for configuring a first device by means of a second device comprises the following steps to be carried out by the first device: detection of an active NFC device by means of an NFC module, in the passive NFC mode, of the first device. If the active NFC device is the second device, the first device transmits status feedback by means of its NFC module in the passive NFC mode. Otherwise, detection is carried on without outputting feedback. After the outputting of the status feedback, configuration data which is emitted by the active NFC device is received by the NFC module in the passive NFC mode. The received configuration data is stored in a configuration data memory of the first device.

Subsequently, either a configuration process of the first device starts on the basis of the stored configuration data or, if no separate configuration step is necessary, the device is operated directly in accordance with the newly stored configuration data. The method according to the invention has the advantage that the NFC module serves only to set up a data connection and to perform data transfer, but no storage of data takes place there locally. This increases the protection against prohibited reading or writing of data from or into the NFC module before or after the execution of the configuration method. Therefore, data tampering and the theft of data are made more difficult. The use of near field communication additionally facilitates the handling and eliminates a certain degree of expenditure on wiring.

A method according to the invention for configuring a first device by means of a second device has the following steps to be carried out by the second device: first, configuration data is produced for the first device. Then, status information is emitted in the active NFC mode. It is detected whether status feedback of a device takes place in the passive NFC mode. If this is the case and if the detected device is the first device, the configuration data which is produced is transmitted to the first device. The second device is preferably a mobile device. The production of the configuration data can therefore take place at any desired location. In order to transmit the configuration data to the first device, the second device is moved into its vicinity, so that a near field communication connection can be set up. The data is then transmitted via this connection. Since all the configuration data has already been produced at this time, the inputting of information at the second device is largely eliminated and the transmission of the configuration data takes place without a large amount of expenditure. This is advantageous in particular if, as a result of the surroundings in which the first device is located, such inputs or the like are possible only with difficulty or in a laborious fashion, for example owing to restricted installation space.

It is also within the scope of the invention to produce the configuration data firstly on a third device, then transmit the data to the second device and then from this device to the first device by means of near field communication. This has the advantage that a relatively small device which does not have to be particularly well designed for inputting data can be used as the mobile device. The data input is then carried out largely on a third device which is more suitable for this purpose, for example a fixed or a mobile computer with a large screen and convenient input means. The transmission from said device to the second device is carried out in a wire-bound or wireless fashion, locally, in a data network, on the Internet or the so-called Cloud. These refinements are also covered by the term of the production of configuration data on the second device.

Authentication of the respective other device and/or of the data received thereby is advantageously carried out. By means of the authentication of the respective other device it is checked whether the respective other device is a device which is suitable for the configuration method, in particular whether the other device is approved for this specific device for the configuration method according to the invention. Furthermore, it is checked whether the configuration data meets certain predefined or predefinable safety requirements and whether it is suitable and approved for overwriting configuration data which is possibly present.

The NFC communication is preferably preceded by a set-up of a connection between the first device and the NFC module of the first device. Subsequent to the NFC communication, the corresponding connection is disconnected. This has the advantage that the device can be configured only if it is connected to the NFC module. This gives rise to an additional gain in safety since an inadvertent or illegitimate configuration owing to the lack of a connection cannot then take place. Furthermore, after the NFC module has been disconnected from the first device it can be used to configure further devices. Therefore, components, and as a result costs, are eliminated. The connection set-up is carried out in a physical fashion here, for example a mechanical and electrical connection is established by means of a plug-type connection. As an alternative to this, the connection set-up takes place in a functional fashion, that is to say without setting up or disconnecting a physical connection, for example via a data bus by assigning the corresponding device to an NFC module which is also located on the data bus. In this way, the advantages of a data bus, for example of the CAN bus, and the advantages of the near field communication are combined with one another.

A storage medium according to the invention contains instructions which, when they are executed by one or more processors of a device, cause the device to execute the method. The storage medium is here a data carrier such as a floppy disk, optical storage medium, USB stick, hard disk or some other suitable storage medium.

A device according to the invention is suitable for carrying out the method according to one or more of the method claims. In particular, such a device has a configuration data memory, an NFC module which is operated in the passive NFC mode, at least one configurable module and a control unit. The NFC module is, according to one advantageous embodiment, a separate component which can be used with the device and can also be disconnected again therefrom. Advantages of these embodiments correspond to those which are specified with respect to the corresponding method.

The configuration data belongs to at least one of the types of data mentioned below. Locking data and unlocking data for locking or unlocking a device or sub-functions of a device. System setting data which serves to describe the system in which the device is located. This comprises, inter alia, settings for filling level sensors, the geometry of a liquid container, a system profile, predefined power limits of a motor or other parameters. Personalization data comprises, for example, logos which are displayed at the start of the device or when it is switched off or in specific operating situations, images, background images, pre-prepared texts, lists of favorites and the like. Vehicle data which is used jointly by a plurality of devices of a vehicle comprises, for example, rotational speed limits, switch-off conditions (also referred to by the expression “disabling features”) and so on. Logbook data and information for collecting data is also included among the configuration data handled according to the invention.

Of course, the specified features are also modified and can be used appropriately in another sequence or in combination as described here and therefore fall under the protection of the patent claims.

### BRIEF DESCRIPTION OF THE DRAWINGS

Apart from the previously mentioned advantages, advantages are also apparent from the following description of exemplary embodiments with reference to the figures, of which:

FIG. 1 shows a flow chart of a method according to the invention for a first device,

FIG. 2 shows a flow chart of a method according to the invention for a second device, and

FIG. 3 shows devices according to the invention.

### DETAILED DESCRIPTION OF THE PREFERRED EMBODIMENTS

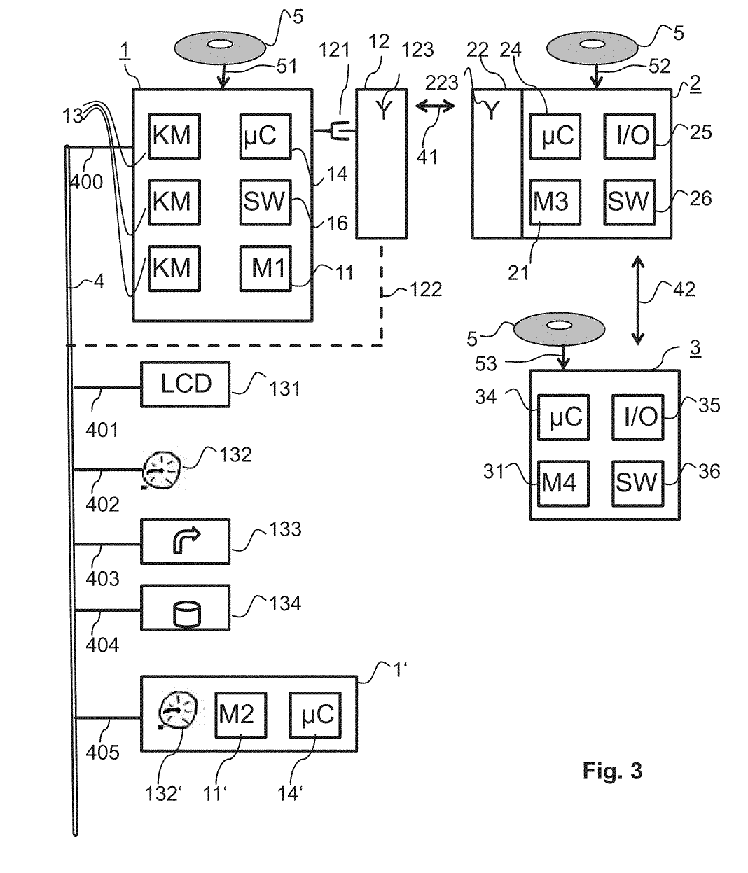

FIG. 1 shows a flow chart of a method according to the invention for a first device 1. With respect to the device 1 and further devices, see also the description of FIG. 3. The method starts with a step S10. In the step S11, the NFC module 12, in the passive NFC mode, of the first device 1 detects whether an NFC device in the active NFC mode is located in its vicinity. In the active NFC mode, a device actively transmits via the antenna of its NFC module. It requires an energy supply for this. In the passive NFC mode, no device-specific energy supply is required for the near field communication. The energy of an active NFC device which is received by the antenna is sufficient to supply the device in the passive NFC mode with the energy necessary for the near field communication. If no active NFC device is detected in the step S11, or if a detected device is not the associated or expected second device 2, the system branches back to the step S11, and otherwise to the step S12. In the step S12, the energy received via the NFC antenna 123 is used to output status feedback by means of the first device. In the step S13 the first device 1 receives configuration data which is emitted by the second device 2 which is in the active NFC mode. In the step S14, the received configuration data is stored in a configuration data memory 11 of the first device 1. In the step S15, the first device is configured on the basis of the stored configuration data. Subsequently, the operation of the first device 1 takes place in the step S16 on the basis of the stored configuration data. If no configuration is necessary in the device 1 but rather the operation takes place directly on the basis of the stored configuration data, the step S15 is eliminated. A longer time period can easily pass between the step S15 and the step S16 if the device 1 is newly configured but is not then directly activated. If a one-time configuration occurs, the method ends after step S16. If it is provided for the device 1 to be re-configured, after step S16 the system branches back to the step S11. This preferably takes place only on the basis of a request by the user, a request by the control unit of the device, or at specific time intervals. In this case, the detection of the step S11 takes place only at a few selected points in time. Undesired or unexpected configuration changes are therefore avoided. Alternatively to this, the step S11 can be carried out continuously, which has the advantage that re-configuration of the device takes place without a large amount of expenditure only when a correspondingly prepared second device 2 approaches if such a “rapid” configuration is desired while accepting a lower level of data security.

According to one variant of the invention, in step S101, a connection is first set up between the first device 1 and the NFC module 12 assigned thereto. This connection is disconnected again in step S132. According to one variant, this disconnection takes place directly after reception of the configuration data in step S132. As an alternative to this, the disconnection takes place in step S142 after the storage of the configuration data received, or in step S152 after the conclusion of the configuration.

According to one variant, the active NFC device is subjected, subsequent to step S11, to authentication in step S111. If the active NFC device is authenticated as the second device 2, the system branches to step S12, and otherwise back to step S11. According to a further variant, in step S131, which follows steps S13, the received configuration data is subjected to authentication. If this cannot be unambiguously authenticated, the system branches back to step S11, and otherwise to step S14 or step S132.

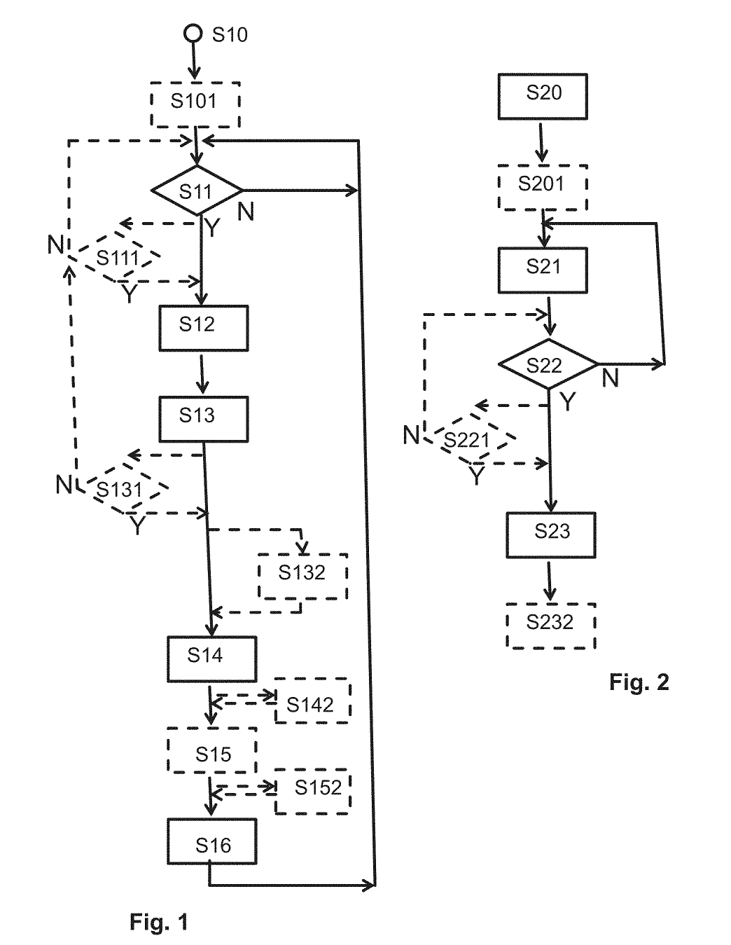

FIG. 2 shows a flowchart of a method according to the invention for a second device 2. In step S20, configuration data is produced for the first device 1. In step S21, status information of the second device 2 is emitted in the active NFC mode. In step S22 it is detected whether status feedback of a device 1 which is operated in the passive NFC mode is present. If this is not the case, the system branches back to step S21, and otherwise to step S23. In step S23, the configuration data is transmitted to the device 1.

According to one variant, in step S221 authentication is carried out of the first device 1 whose status feedback was received in step S22. If it is authenticated as a correct second device, the system branches to step S23, and otherwise to step S22.

According to one variant of the invention, in step S201 a connection is first set up between the second device 2 and the NFC module 22 which is assigned thereto. This connection is disconnected again in step S232. In this case, a second device can be used which is normally operated without an NFC module, and is connected to an NFC module only when necessary.

According to one variant, the production of the configuration data in step S20 does not take place on the second device 2 but rather on a third device 3 from which said data is then transmitted to the second device 2.

FIG. 3 shows devices 1-3 according to the invention. A first device 1 has a configuration data memory 11 which is designated here by M1, an NFC module 12 which is operated in the passive NFC mode, a plurality of configurable modules 13 which are designated here by KM, and a control unit 14, which is designated here by μC. Corresponding designations are also used for other devices, but not necessarily explained there again. The NFC module 12 has an NFC antenna 123 and further elements which are known to a person skilled in the art and are therefore not illustrated here. An element for storing transmitted data is not necessary here, since the configuration data is stored directly in the configuration data memory 11. If an NFC module is used which permits data storage, according to the invention use is not made thereof, in order to achieve the highest possible data security.

The NFC module 12 is shown here as a separate unit which can be connected to the device 1 via a plug-type connection 121, and can be disconnected again therefrom. As an alternative to this, the NFC module 12 is connected to a data bus 4 via a line 122 which is illustrated here by dashed lines. This data bus 4 is connected via a line 400 to the device 1. In this case, the device 1 and the NFC module 12 are connected to one another or disconnected from one another via the data bus 4 instead of via the plug-type connection 121.

On the data bus 4 there are further configurable modules which are connected thereto via lines 401-404: a display device 131, characterized by LCD here, is a screen on which the device 1 visually outputs information to its user. It is in this context an LC display, an LED display, an OLED display, a picture tube or a display according to some other suitable technology. The display device 131 is configured or operated by means of the configuration data which is provided for it and is present in the configuration data memory 11. Furthermore, a measuring instrument 132, a navigation unit 133 and a data memory 134, which records, for example, logbook data of a tachograph of a land vehicle or of a seacraft, are located on the data bus. They are also configured or operated by means of configuration data which is provided for them and is present in the configuration data memory 11. The same applies to the configurable modules 13. If a module 13 serves, for example, for calculating distances, it is configured for the metric measuring system or for a nautical or some other type of measuring system by means of the configuration data which is provided for it. If a module 13 serves to calculate the contents of a tank from a filling level sensor signal, configuration data which describes the geometry of the tank is provided for this module.

On the data bus 4 there is a further first device 1′ which has a measuring instrument 132′ as a configurable module, a configuration data memory 11′, and a control unit 14′. The device 1′ is connected to the NFC module 12 in a data exchange connection via the line 405 and the data bus 4 if it requires configuration data. Otherwise it is disconnected therefrom.

A second device 2 has a configuration data memory 21, an NFC module 22, a control unit 24, a user interface 25 and a command data memory 26. The NFC module 22 is embodied here as a fixed component of the device 2, but can alternatively also be, as shown for the device 1, a separate unit which can be connected to the device 2 and also disconnected again therefrom. The NFC module 22 is operated in the active mode and has, as indicated by means of a double arrow, a near field communication connection 41 via its NFC antenna 223 with the NFC module 12 of the device 1. In the command data memory 26, software, for example a so-called app, also referred to as application, is stored which permits the production of configuration data in the device 2. For this purpose, possible ways of producing and confirming configuration data for a first device 1 are provided to the user by means of menus etc. via the user interface 25. The confirmed configuration data is stored in the configuration data memory 21. The transmission of the configuration data from the configuration data memory 21 into the configuration data memory 11 of the device 1 via the NFC module 22 and the NFC module 12 takes place as described with respect to FIG. 1 and FIG. 2. These actions and all the other actions of the device 2 are controlled via the control unit 24.

The device 2 has an interface 52 (indicated here by an arrow) to a storage medium 5. The storage medium 5 is illustrated schematically as an optical data memory such as CD or DVD and contains instructions which are transferred into the command data memory 26 and enable the device 2 to execute a method according to the invention. A corresponding interface 51,53 also has the devices 1,3 which store instructions from a storage medium 5 in a command data memory 16,36. The instructions stored there permit the devices 1,3 to execute a method according to the invention.

A third device 3 has a configuration data memory 31, a control unit 34, a user interface 35 and a command data memory 36. The device 3 is connected to the device 2 by means of a wireless or wire-bound connection 42, which is not explained in more detail here and is indicated by means of a double arrow. Configuration data can be produced at the device 3, as described with respect to the device 2, and stored in the configuration data memory 31. Said data is then transmitted via the connection 42 to the configuration data memory 21 of the device 2, from where it is transmitted to the device 1 by means of near field communication. According to one variant, the user interface 25 of the device 2 and the instructions specified in the command data memory 26 permit the configuration data produced in the device 3 to be modified or added to in the device 2. In one variant, the user interface 25 and the command data memory 26 are dispensed with, at least in so far as they relate to the configuration of the device 1. The device 2 then serves mainly to transmit the configuration data produced in the device 3 to the device 1.

Of course, the measures which are specified in the individual exemplary embodiments, and in the introduction to the description can also be used appropriately in combinations other than those illustrated, and developments, even if not specified individually, are at the discretion of the person skilled in the art.

1. A method for configuring a first device by a second device the method comprising the steps:
continuously detecting an active NFC device by an NFC module, in the passive NFC mode, of the first device;
if the active NFC device is the second device; outputting status feedback by the first device by its NFC module in the passive NFC mode;
receiving of configuration data emitted by the second device in the active NFC mode by the NFC module of the first device in the passive NFC mode;
storing the received configuration data in a non-transitory configuration data memory of the first device;
starting configuration by the first device on the basis of the stored configuration data and operation of the first device on the basis of the stored configuration data.

2. The method of claim 1, further comprising:
setting up a connection between the first device and the NFC module of the first device, prior to the continuously detecting step;
and the following step of:
disconnecting the connection between the first device and the NFC module of the first device, after performance of the step of receiving configuration data.

3. A method for configuring a first device by a second device, the method comprising the steps of:
producing configuration data for the first device on the second device;
outputting status information by the second device in the active NFC mode;
continuously detecting status feedback of a device operated in the passive NFC mode by the second device in the active NFC mode;
if the detected passive device is the first device transmitting configuration data by the second device to the first device.

4. The method of claim 3, wherein the production of the configuration data for the first device is carried out at least partially on a third device and this configuration data is then transmitted to the second device.

5. The method of claim 4, further comprising: having the further step:
authenticating authentication (S111, S131, S221) of the respective other device and/or of the data received from said device.

6. A non-transitory storage medium containing instructions which when executed, by one or more processors of a device cause the device to:
produce configuration data for the first device on the second device;
output status information by the second device in the active NFC mode;
continuously detect status feedback of a device operated in the passive NFC mode by the second device in the active NFC mode; and
if the detected passive device is the first device, transmit configuration data by the second device to the first device.

7. (canceled)

8. (canceled)
